(19) United States
(12) Patent Application Publication
(10) Pub. No.: US 2005/0187364 A1
(43) Pub. Date: Aug. 25, 2005

(54) Polymers having pendant triarylmethane groups and electronic devices made with such polymers

(76) Inventors: Norman Herron, Newark, DE (US); Gary A. Johansson, Hockessin, DE (US); Nora Sabina Radu, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/045,190

(22) Filed: Jan. 28, 2005

Related U.S. Application Data
(60) Provisional application No. 60/545,770, filed on Feb. 19, 2004.

(51) Int. Cl. H01B 1/12; C08F 12/32

(52) U.S. Cl. 526/310; 313/504; 313/506; 257/40; 526/326; 526/334; 526/285; 428/917

(57) ABSTRACT

The present invention relates to a new polymer made from Monomer (I) 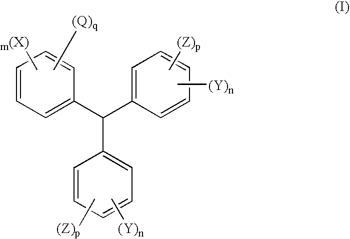 wherein: X is the same or different at each occurrence and comprises a polymerizable group,
Y is NR₂, Z is the same or different at each occurrence and is selected from X, F, Cl, Br, I, alkyl, aryl, heteroalkyl, heteroaryl, fluoroalkyl, fluoroaryl, and a crosslinkable group, Q is the same or different at each occurrence and is selected from F, Cl, Br, I, alkyl, aryl, heteroalkyl, heteroaryl, fluoroalkyl, fluoroaryl, R is the same or different at each occurrence and is selected from X, H, alkyl, aryl, heteroalkyl, heteroaryl, fluoroalkyl, fluoroaryl, arylalkyl, and a crosslinkable group, or two R groups on the same N can together form a non-aromatic ring, m is an integer from 1 through 5, n is the same or different at each occurrence and is an integer from 1 through 5, p is the same or different at each occurrence and is 0 or an integer from 1 through 4, and q is 0 or an integer from 1 through 4.

### BACKGROUND OF THE INVENTION

1. Field of the Invention

The present invention relates to polymers having pendant triarylmethane groups and the monomers for making such polymers. The invention further relates to organic electronic devices in which there is at least one active layer comprising such polymers.

2. Background

In organic photoactive electronic devices, such as light-emitting diodes (“OLED”), that make up OLED displays, the organic active layer is sandwiched between two electrical contact layers in an OLED display. In an OLED the organic photoactive layer emits light through the light-transmitting electrical contact layer upon application of a voltage across the electrical contact layers.

It is well known to use organic electroluminescent compounds as the active component in light-emitting diodes. Simple organic molecules, conjugated polymers, and organometallic complexes have been used.

Devices which use photoactive materials, frequently include one or more charge transport layers, which are positioned between the photoactive (e.g., light-emitting) layer and one of the contact layers. A hole transport layer may be positioned between the photoactive layer and the hole-injecting contact layer, also called the anode. An electron transport layer may be positioned between the photoactive layer and the electron-injecting contact layer, also called the cathode.

Hole transport polymers are well known. Small molecule hole transport materials have been disclosed in, for example, Strohriegel, P.; Grazulevicius, J. V. Adv. Mater. 2002, 14, 1439, and published PCT application WO 2004/005406.

There is a continuing need for charge transport materials.

### SUMMARY OF THE INVENTION

The invention is directed to a new polymer made from Monomer (I) 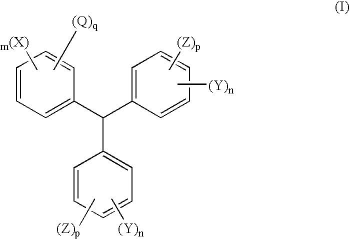
wherein:
   X is the same or different at each occurrence and comprises a polymerizable group,
   Y is NR₂,
   Z is the same or different at each occurrence and is selected from X, F, Cl, Br, I, alkyl, aryl, heteroalkyl, heteroaryl, fluoroalkyl, fluoroaryl, and a crosslinkable group,
   Q is the same or different at each occurrence and is selected from F, Cl, Br, I, alkyl, aryl, heteroalkyl, heteroaryl, fluoroalkyl, fluoroaryl,
   R is the same or different at each occurrence and is selected from X, H, alkyl, aryl, heteroalkyl, heteroaryl, fluoroalkyl, fluoroaryl, arylalkyl, and a crosslinkable group, or two R groups on the same N can together form a non-aromatic ring,
   m is an integer from 1 through 5,
   n is the same or different at each occurrence and is an integer from 1 through 5,
   p is the same or different at each occurrence and is 0 or an integer from 1 through 4, and
   q is 0 or an integer from 1 through 4.

Another embodiment is a new charge transport layer comprising the above polymer.

Another embodiment is a new organic electronic device having at least one layer comprising the above polymer.

The foregoing general description and the following detailed description are exemplary and explanatory only and are not restrictive of the invention, as defined in the appended claims.

### DESCRIPTION OF THE DRAWINGS

The invention is illustrated by way of example and not limitation in the accompanying figures.

FIG. 1: An illustrative example of one organic electronic device comprising at least one layer comprising the new polymer.

### DETAILED DESCRIPTION OF THE PREFERRED EMBODIMENTS

In one embodiment, the invention is directed to a new polymer made from Monomer (I) 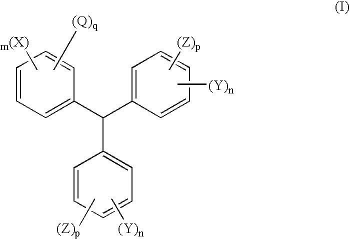
wherein:
   X is the same or different at each occurrence and comprises a polymerizable group,
   Y is NR₂,
   Z is the same or different at each occurrence and is selected from X, F, Cl, Br, I, alkyl, aryl, heteroalkyl, heteroaryl, fluoroalkyl, fluoroaryl, and a crosslinkable group,
   Q is the same or different at each occurrence and is selected from F, Cl, Br, I, alkyl, aryl, heteroalkyl, heteroaryl, fluoroalkyl, fluoroaryl,
   R is the same or different at each occurrence and is selected from X, H, alkyl, aryl, heteroalkyl, heteroaryl, fluoroalkyl, fluoroaryl, arylalkyl, and a crosslinkable group, or two R groups on the same N can together form a non-aromatic ring,
   m is an integer from 1 through 5,
   n is the same or different at each occurrence and is an integer from 1 through 5,
   p is the same or different at each occurrence and is 0 or an integer from 1 through 4, and
   q is 0 or an integer from 1 through 4.

The new polymer can be a homopolymer of Monomer (I), a copolymer of two or more different monomers having the formula of Monomer (I), or a copolymer of Monomer (I) with one or more different monomers. The polymer has pendant triarylmethane groups, which have hole transport properties. The polymer can be formed into films.

In Monomer (I), X can comprise any polymerizable group. Examples of such types of groups include, but are not limited to, alkenylene groups, alkynylene groups, cyclic ethers, acrylates, and methacrylates. The number of X groups on the phenyl ring, hereinafter referred to as the “first phenyl ring”, can be from 1 to 5, as indicated by “m”.

In one embodiment, the polymerizable group is attached directly to the first phenyl ring without any linking group. The polymers made from this monomer thus have a high percentage of triarylmethane functional groups. There is less non-functional material present in the polymer.

In one embodiment of Monomer (I), X is an ethylene group. In polymers made from this monomer, there are no polar groups or other groups which might act as hole traps. In addition, greater than 90% by weight of the polymer is made up of the triarylmethane functional group. Thus the properties should be similar to the simple molecule analogs. In one embodiment, the ethylene group is further substituted with alkyl or aryl groups in the alpha or beta position.

In one embodiment of Monomer (I), X comprises a polymerizable group and a linking group. The linking group can be selected from an alkylene, heteroalkylene, arylene, and heteroarylene group.

In Monomer (I), Q is an additional substituent on the first phenyl ring. The number of Q groups on the first phenyl ring can be from 0 to 4, as indicated by “q”. In one embodiment Q is an alkyl group. In one embodiment, the alkyl group has from 1 to 20 carbon atoms. In one embodiment, the alkyl group has from 1 to 6 carbon atoms.

It will be understood that for a given phenyl ring, when m+q is less than 5, the other positions on the phenyl ring are occupied by hydrogen.

In Monomer (I), Y is NR₂. There is at least one Y group present on each of two phenyl rings, hereinafter referred to as the “second phenyl ring” and the “third phenyl ring”, as indicated by “n”. In one embodiment, R is an alkyl group having from 1 to 20 carbon atoms. In one embodiment, the alkyl group has from 1 to 6 carbon atoms. In one embodiment, R is an aryl group or an arylakyl group. In one embodiment, R is selected from phenyl, benzyl, and naphthyl. In one embodiment, both R groups together form a carbazole group.

In Monomer (I), Z is a substituent. There can be different Z groups on the same phenyl ring, and the Z groups on the second phenyl ring can be the same as or different from the Z groups on the third phenyl ring. The number of Z groups on the phenyl ring can be from 0 to 4, as indicated by “p”. In one embodiment Z is an alkyl group. In one embodiment, the alkyl group has from 1 to 20 carbon atoms. In one embodiment, the alkyl group has from 1 to 6 carbon atoms.

In one embodiment, Z is an aryl group. In one embodiment, the aryl group is selected from phenyl and naphthyl.

It will be understood that for a given phenyl ring, when n+p is less than 5, the other positions on the phenyl ring are occupied by hydrogen.

In one embodiment, for each of the second and third phenyl rings, n=1 and p=1. In one embodiment, m=1, q=0, for each of the second and third phenyl rings, n=1, p=1 and Z is an alkyl group. In one embodiment, Monomer (I) has the structure below:

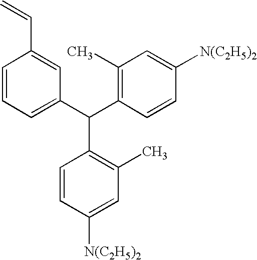

In one embodiment, the polymers made from Monomer (I) are crosslinked. This can result in more robust films. In one embodiment, there is more than one X group in Monomer (I). The X groups can be on the same phenyl ring, when m is 2 or greater. Alternatively, there can be an X group on one or both of the other phenyl rings, where Y═X, or R═X.

In one embodiment, Z is a crosslinkable group. A crosslinkable group is one which will react with the same group or a different group on another monomer, resulting in a crosslinked or networked structure. The crosslinking can take place during polymerization. In one embodiment, at least one Z is a photosensitive or thermally sensitive group and crosslinking can be initiated after polymerization. Polymers having these groups can be formed into films, and then treated with heat or actinic radiation to crosslink. The resulting crosslinked films will be more robust and resistant to solvents which may be used in later processing steps. Crosslinking groups are well known, and any can be used so long as they do not detrimentally affect the desired properties of the polymer. Examples of suitable crosslinking groups include, but are not limited to vinyl groups (e.g. ethenyl (CH2═CH—)), propenyl ((CH3)(H)C═CH—), acryloyl (CH2=CH—C(O)—O—), and methacryloyl (CH2═C(CH3)-C(O)—O—), cyclic ethers, cinnamoyl esters, benzocyclobutane, and siloxanes. In addition, a cross-linkable group can be any organic fragment that can bind to a preformed support, and may be further polymerized after it is bound to the support. Any organic or inorganic material can be used as a support as long as it meets desired solubility properties, and has reactive sites that can covalently link a compound to the surface thereof. Such materials are well known and include polystyrene, polyalcohols, polyacrylates, and polysilanes.

In one embodiment, the new polymer comprises a copolymer of Monomer (I) and one or more second monomers. The second monomer can be selected to modify or enhance the physical or electrical properties of the polymer. In one embodiment, the second monomer comprises a charge transport moiety. In one embodiment, the second monomer comprises two or more polymerizable groups so the new polymer will be crosslinked or networked. In one embodiment, the second monomer comprises a solubilizing group so that the new polymer will have increase solubility in solvents. In one embodiment, the second monomer comprises a group which will alter the morphology of films made from the new polymer. Exemplary second monomers include, but are not limited to aromatic vinyl compounds (e.g. styrene, a-methylstyrene, p-hydroxystyrene, vinyl toluene), an acrylic monomer (e.g., (meth)acrylic acid, (meth)acrylic esters and other (meth)acrylic boilerplate), a vinyl cyanide (e.g., acrylonitrile, fumaronitrile), a vinyl ester (e.g., vinyl acetate and other vinyl ester boilerplate), a vinyl ether (e.g., alkyl vinyl ether), a vinyl halide (e.g., vinyl chloride, vinylidene fluoride), an unsaturated polycarboxylic acid, ester or anhydride (e.g., diethyl fumarate, diethyl maleate, fumaric acid, maleic acid, itaconic acid, citraconic acid, maleic anhydride), a maleimide (e.g., N-alkylmaleimide, N-arylmaleimide, N-cycloalkylmaleimide) a substituted or unsubstituted vinylcarbazole (e.g., vinylcarbazole, N-4-ethenylphenylcarbazole, (meth)acrylic ester of N-4-alkylphenylcarbazole), a (meth)acrylic ester of an alkyl substituted N-phenylcarbazole, an N,N-diphenylaminophenylalkyl(meth)acrylate), a vinylferrocene and others.

The monomers represented by Monomer (I) can be prepared using standard synthetic organic techniques. Known aromatic coupling reactions between aromatic aldehydes and N,N-disubstituted anilines having an active ring H are useful. Aromatic coupling reactions can be carried out in the presence of stoichiometric or catalytic amounts of protonic acids, such as hydrochloric acid, sulfuric acid, p-toluenesulfonic acid, methanesulfonic acid and others in a suitable solvent. Catalytic reactions employ from about 0.00001 to 0.10 parts by weight of the combined reactants. Suitable solvents for carrying out the reactions include alkanols such as ethanol, propanol, isopropanol, n-butanol, n-pentanol and higher alkanols or aromatic hydrocarbons such as benzene, toluene or xylene.

The new polymer made from Monomer (I) can be prepared using any standard polymerization technique, depending on the nature of X. When X includes a group with ethylenic unsaturation, the new polymer can be made by radical polymerization. The radical initiator can be any conventional radical initiator, for example, an azo-series compound [e.g., azobisisobutyronitrile (AIBN), dimethylazoisobutylate, benzene diazonium chloride], or a peroxide (e.g., benzoyl peroxide, di-t-butyl peroxide, t-butyl perbenzoate, hydrogen peroxide). The ratio of the radical initiator to monomer is not particularly limited. In one embodiment the ratio is about 0.01 to 20 parts by weight relative to 100 parts of total monomer. In one embodiment, the ratio is about 0.1 to 10 parts by weight. In one embodiment, the ratio is about 1 to 5 parts by weight. Under certain conditions, the free radical polymerization of Monomer (I) can be carried out in such a way as to possess characteristics of so-called “living” or “controlled” polymerization processes. Such processes can lead to polymers with narrow molecular weight distributions (M_{w}/Mₙ<2) and may permit formation of block copolymers by sequential addition of polymerizable monomers. Furthermore, the polymer molecular weight can be easily controlled by the ratio of monomer to initiator. Examples of free radical polymerizations that proceed in a “controlled” or “living” process include but are not limited to Atom Transfer Radical Polymerization (ATRP), Nitroxide Mediated Polymerization (NMP) and Radical Addition Fragmentation Transfer (RAFT) polymerization of vinyl and (meth)acryl functional monomers. These polymerizations habe been described by K. Matyjaszewski in “Advances in Controlled/Living Radical Polymerization”, American Chemical Society, Washington, D.C.,.

The polymerization can be carried out in a conventional method, for example, solution polymerization, suspension polymerization. As a solvent for solution polymerization, a variety of solvents which dissolve (or can dissolve) a formed polymer can be employed, such as an aromatic hydrocarbon, an ester, a ketone, an ether and others.

The polymerization temperature is not particularly limited, and can be selected within the wide range of about 0 to 200° C. In one embodiment, the temperature is in the range of about 20° C. to 100° C. The polymerization time is not particularly limited. In one embodiment, the polymerization time is within the range of about 0.5 to 72 hours. The polymerization can be carried out in an atmosphere of an inert gas.

The formed polymer can be separated and purified by any conventional manner, such as precipitation or column chromatography.

In one embodiment, the polymer is a low molecular weight oligomer having two to ten monomer units. In one embodiment the oligomer has from five to ten monomer units.

In one embodiment, the new polymer has greater than ten monomer units. The practical upper limit of the number of monomer units is determined in part by the desired solubility of a polymer in a particular solvent or class of solvents. As the number increases, the molecular weight of the polymer increases. The increase in molecular weight is generally expected to result in a reduced solubility of the polymer in a particular solvent. Moreover, the number of monomer units at which a polymer becomes substantially insoluble in a given solvent is dependent in part upon the structure of the polymer and the specific substituents. For example, a compound containing multiple phenyl groups may become substantially insoluble in an organic solvent when the number of monomer units is much less than about 10⁴. As another example, a compound containing fewer phenyl groups and/or phenyl groups with particular functional groups may be soluble in a given solvent even though the number of monomer units is about 10⁴ or greater, even 10⁵ or 10⁶. The selection of the number of monomer units in the new polymer and a preferred solvent is within the purview of one skilled in the art.

The new polymer can be formed into films by any conventional means. The new polymer can be formed into pure films, or it can be combined with other materials in films. The lower molecular weight polymers can, in some cases, be sublimed intact. Thin films of these materials can be obtained via vacuum deposition. However, it is frequently advantageous to deposit the new polymers by solution processing. As used herein, “solution processing” means processes that include depositing from a liquid medium. The liquid medium can be in the form of a solution, a dispersion, an emulsion, or other forms. Typical deposition techniques include, but are not limited to, continuous deposition techniques such as spin coating, gravure coating, curtain coating, dip coating, slot-die coating, spray-coating, and continuous nozzle coating; and discontinuous deposition techniques such as ink jet printing, gravure printing, and screen printing.

Some exemplary solvents for the new polymer include, but are not limited to toluene, tetrahydrofuran, chloroform, and ethylacetate. Other suitable liquids include, but are not limited to, chlorinated hydrocarbons (such as methylene chloride, chloroform, chlorobenzene), aromatic hydrocarbons (such as substituted and non-substituted toluenes and xylenes), including triflurotoluene), polar solvents (such as tetrahydrofuran (THP), N-methylpyrrolidone) esters (such as ethylacetate) alcohols (isopropanol), keytones (cyclopentatone) and mixtures thereof.

Another embodiment of the invention is a new charge transport layer comprising the polymer described above. The new charge transport layer can be used in any application where the transport property is desired. In one embodiment, the new charge transport layer is a hole transport layer. Examples of some uses include, but are not limited to organic light-emitting diodes (“OLED”s), photovoltaic cells, light sensors, thin film organic transistors, photoconductors, and electrophotographic devices.

Electronic Device

Another embodiment is a new organic electronic device comprising at least one layer comprising the above polymer. The polymer can be in a separate layer or can be combined with other active materials in the device.

Organic electronic devices that may benefit from having one or more layers comprising the new polymer include (1) devices that convert electrical energy into radiation (e.g., a light-emitting diode, light emitting diode display, or diode laser), (2) devices that detect signals through electronics processes (e.g., photodetectors (e.g., photoconductive cells, photoresistors, photoswitches, phototransistors, phototubes), IR detectors), (3) devices that convert radiation into electrical energy, (e.g., a photovoltaic device or solar cell), and (4) devices that include one or more electronic components that include one or more organic semi-conductor layers (e.g., a transistor or diode).

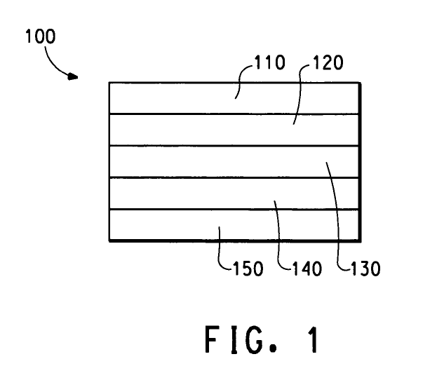

An illustration of one type of organic electronic device structure is shown in FIG. 1. The device 100 has an anode layer 110 and a cathode layer 160. Adjacent to the anode is a layer 120 comprising hole transport material. Adjacent to the cathode is a layer 140 comprising an electron transport and/or anti-quenching material. Between the hole transport layer and the electron transport and/or anti-quenching layer is the photoactive layer 130. As an option, devices frequently use another electron transport layer 150, next to the cathode. Layers 120, 130, 140, and 150 are individually and collectively referred to as the active layers.

Depending upon the application of the device 100, the photoactive layer 130 can be a light-emitting layer that is activated by an applied voltage (such as in a light-emitting diode or light-emitting electrochemical cell), a layer of material that responds to radiant energy and generates a signal with or without an applied bias voltage (such as in a photodetector). Examples of photodetectors include photoconductive cells, photoresistors, photoswitches, phototransistors, and phototubes, and photovoltaic cells, as these terms are describe in Markus, John, Electronics and Nucleonics Dictionary, 470 and 476 (McGraw-Hill, Inc. 1966).

The new polymers are particularly useful as the hole transport layer 120, and as a charge transporting host in the photoactive layer, 130. The other layers in the device can be made of any materials which are known to be useful in such layers. The anode 110, is an electrode that is particularly efficient for injecting positive charge carriers. It can be made of, for example materials containing a metal, mixed metal, alloy, metal oxide or mixed-metal oxide, or it can be a conducting polymer, and mixtures thereof. Suitable metals include the Group 11 metals, the metals in Groups 4, 5, and 6, and the Group 8-10 transition metals. If the anode is to be light-transmitting, mixed-metal oxides of Groups 12, 13 and 14 metals, such as indium-tin-oxide, are generally used. The anode 110 may also comprise an organic material such as polyaniline as described in “Flexible light-emitting diodes made from soluble conducting polymer,” Nature vol. 357, pp 477-479 (11 Jun. 1992). At least one of the anode and cathode should be at least partially transparent to allow the generated light to be observed.

Examples of the photoactive layer 130 include all known electroluminescent materials, including fluorescing and phosphorescing materials (including both organo-metallic complexes and conjucgated polymers). In one embodiment, the electroluminescent material is anorganometallic compound. In one embodiment, the electroluminescent material includes cyclometalated iridium and platinum electroluminescent compounds and mixtures thereof. Complexes of Iridium with phenylpyridine, phenylquinoline, or phenylpyrimidine ligands have been disclosed as electroluminescent compounds in Petrov et al., Published PCT Application WO 02/02714. Other organometallic complexes have been described in, for example, published applications U.S. 2001/0019782, EP 1191612, WO 02/15645, and EP 1191614. Electroluminescent devices with an active layer of polyvinyl carbazole (PVK) doped with metallic complexes of iridium have been described by Burrows and Thompson in published PCT applications WO 00/70655 and WO 01/41512. Electroluminescent emissive layers comprising a charge carrying host material and a phosphorescent platinum complex have been described by Thompson et al., in U.S. Pat. No. 6,303,238, Bradley et al., in Synth. Met. (2001), 116 (1-3), 379-383, and Campbell et al., in Phys. Rev. B, Vol. 65 085210. Examples of a few suitable iridium complexes are given in FIG. 6, as Formulae IV(a) through IV(e). Analogous tetradentate platinum complexes can also be used. These electroluminescent complexes can be used alone, or doped into charge-carrying hosts, as noted above.

Examples of electron transport materials which can be used in layer 140 and/or layer 150 include metal chelated oxinoid compounds, such as tris(8-hydroxyquinolato)aluminum (Alq₃); and azole compounds such as 2-(4-biphenylyl)-5-(4-t-butylphenyl)-1,3,4-oxadiazole (PBD) and 3-(4-biphenylyl)-4-phenyl-5-(4-t-butylphenyl)-1,2,4-triazole (TAZ), and mixtures thereof.

The cathode 160, is an electrode that is particularly efficient for injecting electrons or negative charge carriers. The cathode can be any metal or nonmetal having a lower work function than the anode. Materials for the cathode can be selected from alkali metals of Group 1 (e.g., Li, Cs), the Group 2 (alkaline earth) metals, the Group 12 metals, including the rare earth elements and lanthanides, and the actinides. Materials such as aluminum, indium, calcium, barium, samarium and magnesium, as well as combinations, can be used. Li-containing organometallic compounds, LiF, and Li₂O can also be deposited between the organic layer and the cathode layer to lower the operating voltage.

It is known to have other layers in organic electronic devices. For example, there can be a layer (not shown) between the anode 110 and hole transport layer 120 to facilitate positive charge transport and/or band-gap matching of the layers, or to function as a protective layer. Layers that are known in the art can be used. In addition, any of the above-described layers can be made of two or more layers. Alternatively, some or all of anode layer 110, the hole transport layer 120, the electron transport layers 140 and 150, and cathode layer 160, may be surface treated to increase charge carrier transport efficiency. The choice of materials for each of the component layers is preferably determined by balancing the goals of providing a device with high device efficiency with device operational lifetime.

It is understood that each functional layer may be made up of more than one layer.

The device can be prepared by a variety of techniques, including sequentially vapor depositing the individual layers on a suitable substrate. Substrates such as glass and polymeric films can be used. Conventional vapor deposition techniques can be used, such as thermal evaporation, chemical vapor deposition, and the like. Alternatively, the organic layers can be applied from solutions or dispersions in suitable solvents, using any conventional coating or printing technique, including but not limited to spin-coating, dip-coating, roll-to-roll techniques, ink-jet printing, screen-printing, gravure printing and the like. In general, the different layers will have the following range of thicknesses: anode 110, 500-5000 Å, preferably 1000-2000 Å; hole transport layer 120, 50-2000 Å, preferably 200-1000 Å; photoactive layer 130, 10-2000 Å, preferably 100-1000 Å; electron transport layer 140 and 150, 50-2000 Å, preferably 100-1000 Å; cathode 160, 200-10000 Å, preferably 300-5000 Å. The location of the electron-hole recombination zone in the device, and thus the emission spectrum of the device, can be affected by the relative thickness of each layer. Thus the thickness of the electron-transport layer should be chosen so that the electron-hole recombination zone is in the light-emitting layer. The desired ratio of layer thicknesses will depend on the exact nature of the materials used.

As used herein, the term “charge transport” is intended to mean the ability to receive a charge from an electrode and facilitate its movement with relatively high efficiency and small loss of charge. Hole transport is the ability to receive a positive charge from an anode and transport it. Electron transport is the ability to receive a negative charge from a cathode and transport it.

The term “photoactive” refers to any material that exhibits electroluminescence, photoluminescence, and/or photosensitivity.

The term “group” is intended to mean a part of a compound, such as a substituent in an organic compound.

The term “alkyl” is intended to mean a group derived from an aliphatic hydrocarbon having one point of attachment. The term “alkylene” is intended to mean a group derived from an aliphatic hydrocarbon and having two or more points of attachment.

The term “alkenyl” is intended to mean a group derived from a hydrocarbon having one or more carbon-carbon double bonds and having one point of attachment. The term “alkenylene” is intended to mean a group derived from a hydrocarbon having one or more carbon-carbon double bonds and having two or more points of attachment.

The term “alkynyl” is intended to mean a group derived from a hydrocarbon having one or more carbon-carbon triple bonds and having one point of attachment. The term “alkynylene” is intended to mean a group derived from a hydrocarbon having one or more carbon-carbon triple bonds and having two or more points of attachment.

The term “aryl” is intended to mean a group derived from an aromatic hydrocarbon having one point of attachment. The term “arylene” is intended to mean a group derived from an aromatic hydrocarbon having two points of attachment.

The term “arylalkyl” is intended to mean an alkyl group with an aryl substituent.

Unless otherwise indicated, all groups can be unsubstituted or substituted.

The term “film” refers to a coating covering a desired area. The area can be as large as an entire display, or as small as a single sub-pixel. Films can be formed by any conventional deposition technique, including vapor deposition and liquid deposition. Typical liquid deposition techniques include, but are not limited to, continuous deposition techniques such as spin coating, gravure coating, curtain coating, dip coating, slot-die coating, spray-coating, and continuous nozzle coating; and discontinuous deposition techniques such as ink jet printing, gravure printing, and screen printing.

The term “monomer” refers to a compound capable of being polymerized. The term “monomeric unit” refers to units which are repeated in a polymer.

The term “polymeric” is intended to encompass oligomeric species and include materials having 2 or more monomeric units.

The phrase “adjacent to,” when used to refer to layers in a device, does not necessarily mean that one layer is immediately next to another layer. On the other hand, the phrase “adjacent R groups,” is used to refer to R groups that are next to each other in a chemical formula (i.e., R groups that are on atoms joined by a bond).

The prefix “fluoro” indicates that one or more hydrogen atoms has been replaced with a fluorine.

The prefix “hetero” indicates that one or more carbon atoms has been replaced with a different atom.

In addition, the IUPAC numbering system is used throughout, where the groups from the Periodic Table are numbered from left to right as 1 through 18 (CRC Handbook of Chemistry and Physics, 81^{st} Edition, 2000).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, “the”, “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Unless otherwise defined, all letter symbols in the figures represent atoms with that atomic abbreviation. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### EXAMPLES

The following examples illustrate certain features and advantages of the present invention. They are intended to be illustrative of the invention, but not limiting. All percentages are by weight, unless otherwise indicated.

### Example 1

This example illustrates the preparation of one example of Monomer (I), 3-bis(4-diethylamino-2-methylphenyl)methylstyrene, shown below.

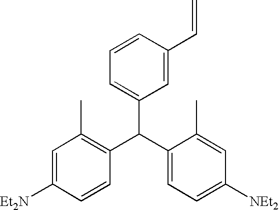

5.0 g 3-vinylbenzaldehyde and 11.0 g N,N-diethyltoluidine were mixed in 10 mL ethanol and 3.4 mL concentrated HCl. The mixture was then gently refluxed under nitrogen for 48 hrs. The resulting material was poured into 25 mL water and the pH was adjusted to 8 with sodium hydroxide solution (1N). The ethanol solvent was concentrated on a rotary evaporator and the aqueous supernatant was decanted from the greenish organic layer. The organic layer was washed with 100 mL distilled water and then triturated with dry ethanol until it became a tan colored solid. After recrystallization from boiling ethanol, the material was rapidly chromatographed on neutral alumina using methylene chloride eluent to remove colored impurities and aldehyde contaminants. The resulting white solid was collected and dried in vacuum. Yield 4.5 g ˜34%.

### Example 2

This example illustrates the preparation of a new polymer.

Into a clean, dry 25 cc Schlenk tube was added 4.0 mg (0.0016 mmol) 2,2′-azobis(2,4-dimethylvaleronitrile) (Vazo® 52, DuPont) and 0.80 g (1.82 mmol) 3-bis(4-diethylamino-2-methylphenyl)methylstyrene from Example 1. A total of 0.62 mL anhydrous tetrahydrofuran (THF) was added to the tube. A magnetic stir bar was placed in the tube, the tube was sealed with a screw cap and the polymerization mixture was stirred for several minutes until the monomer and initiator were completely dissolved. The contents of the Schlenk tube were degassed with three freeze-pump-thaw cycles. After de-gassing, and refilling with nitrogen the Schlenk tube was immersed in an oil bath at 56° C. and heated for 16 hours with stirring. The tube was removed from the oil bath and allowed to cool to room temperature. The viscous polymer was dissolved in 12 mL toluene. The toluene solution was diluted with a total of 120 mL hexanes added in several portions. The resultant white precipitate was collected by vacuum filtration and dried on a high vacuum line for several hours. The polymer yield was 90% of the theoretical yield.

The polymer prepared according to this Example was analyzed by gel permeation chromatography (GPC), using THF as solvent. Molecular weights were determined by calibration against polystyrene GPC standards. The polymer prepared according to this Example had a M_{w}=262,000; Mₙ=47,200, and PDI=5.56.

### Example 3

This example illustrates the preparation of a nitroxide mediator for controlled radical polymerization.

### Synthesis of (1-t-butylamino-2,2-dimethylpropyl)phosphonic Acid Diethyl Ester

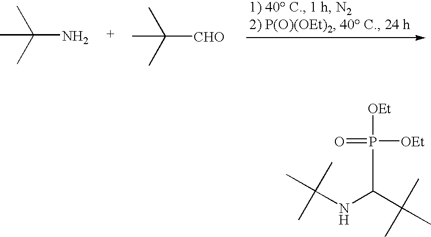

Freshly distilled t-butylamine (3.66 g, 50 mmol) and trimethylacetaldehyde (4.31 g, 50 mmol) were weighed into a clean, dry 50 mL Schlenk tube equipped with a magnetic stirrer. The Schlenk tube was flushed with an argon sweep and then sealed with a screw top. The reaction was heated to 40° C. in a thermostatted oil bath for 1 h. The reaction was cooled to room temperature and diethyl phosphite (13.8 g, 100 mmol) was added slowly via a syringe through the Schlenk tube sidearm. The reaction was reheated to 40-50° C. and stirred for an additional 24 h. Heat was removed and the reaction was allowed to stand for 3 days. The contents were poured into 100 mL water extracted three times with 50 mLs diethyl ether. The ether extracts were washed with 100 mLs water, dried over sodium sulfate and the solvent removed on a rotary evaporator. The product (3.34 g) was obtained by short path vacuum distillation as a clear, oil. The yield was 24.0%.

### Synthesis of N-[1-diethylphosphono(2,2-dimethylpropyl)]nitroxide

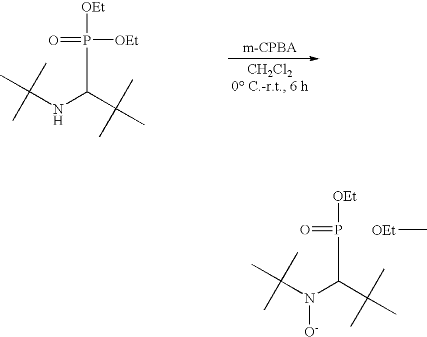 A clean, dry 125 mL flask equipped with a thermometer, addition funnel, argon inlet-outlet and magnetic stirrer was charged with (1-t-butylamino-2,2-dimethylpropyl)phosphonic acid diethyl ester (3.04 g, 10.9 mmol) dissolved in 13 mL dichloromethane. The solution was cooled to 0° C. and a solution of m-chloroperbenzoic acid (2.74 g, 10.8 mmol) dissolved in 23 mL dichloromethane was added slowly. The mixture was stirred at 0° C. for several hours and then allowed to warm to room temperature and stand overnight. The reaction mixture was neutralized with 8% NaHCO₃, washed successively with 50 mis water, 50 mLs 1 N aqueous H₂SO₄, and 50 mLs saturated NaCl solution. The dichloromethane solution was dried over Na₂SO₄, filtered and the solvent removed on a rotary evaporator. The crude product was purified by flash column chromatography (silica gel 60, 1:1:6 dichloromethane:THF:hexanes) to yield 750 mg of an orange oil. The product yield was 23.4%.

### Example 4

This example illustrates the preparation of a new polymer with narrow polydispersity and controlled molecular weight. 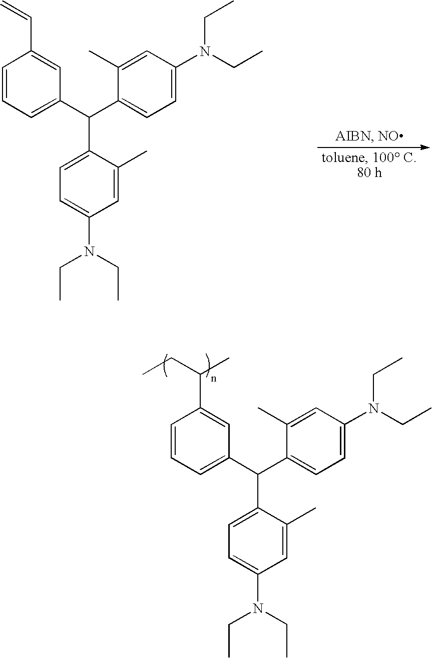
A clean, dry Schlenk tube equipped with a rubber septum and magnetic stirrer was charged with 2,2′-azobisisobutyronitrile (7.0 mg, 0.043 mmol), the monomer of Example 1 (2.0 g, 4.25 mol), nitroxide of Example 3 (32.8 mg, 0.106 mmol) and 2 mL toluene. The contents were degassed with three freeze-pump-thaw cycles and then the Schlenk tube was immersed in a thermostatted oil bath at 100° C. After 80 h, the polymerization mixture was allowed to cooled to room temperature and then diluted with several mLs toluene. The polymer was purified by precipitation of the toluene solution into stirring hexanes. The polymer was collected by vacuum filtration and allowed to dry overnight on the filter in air. After drying, 1.40 g of a very pale green powder was obtained.

The polymer prepared according to this Example was analyzed by gel permeation chromatography (GPC), using THF as solvent. Molecular weights were determined by calibration against polystyrene GPC standards. The polymer prepared according to this Example was free of unreacted monomer and had a M_{w}=25,100; Mₙ=15,700, and PDI=1.60.

### Example 5

This example illustrates the preparation of one example of Monomer (I) containing a functional group for attachment to a polymer support and a second cross-linkable group, 4-bis(4-diethylamino-2-methylphenyl)methylcinnamic acid, shown below.

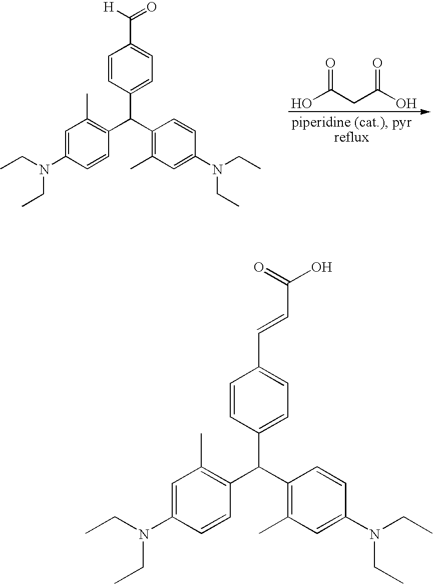

The aldehyde was made according to the procedure in Example 6 of WO 2004/005406, but with a 2:1 molar ratio of m-diethylamino-toluene to isophthalaldehyde.

Malonic acid was dried over phosphorous pentoxide under high vacuum. A clean, dry 50 mL round bottom flask equipped with a condenser, nitrogen inlet-outlet and stirrer was charged with the aldehyde (3.3 g, 7.5 mmol) and malonic acid (1.0 g, 9.6 mmol). The reactants were dissolved in 20 mLs pyridine and then piperidine (0.08 mL, 11 mol %) was added. The reaction mixture was protected from light and gently heated at reflux under nitrogen for 16 hrs after which time additional malonic acid (1.0 g, 9.6 mmol) and piperidine (0.08 mL, 11 mol %) was added. Reaction was gently refluxed and additional 16 h and then cooled to room temperature. The contents were poured into 300 mLs stirring ice water and then allowed to stand for 1 h. The crude product was collected by vacuum filtration and then triturated in 300 mL refluxing ether. The ether suspension was allowed to cool to room temperature and the product was collected by vaccuum filtration. After drying on a high vacuum line, 2 g of the pure product was obtained as a yellow solid. The yield of the reaction was 55%.

1. A polymer made from Monomer (I) 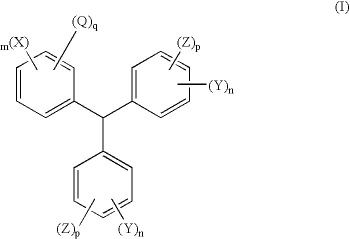
wherein:
X is the same or different at each occurrence and comprises a polymerizable group,
Y is NR₂,
Z is the same or different at each occurrence and is selected from X, F, Cl, Br, I, alkyl, aryl, heteroalkyl, heteroaryl, fluoroalkyl, fluoroaryl, and a crosslinkable group,
Q is the same or different at each occurrence and is selected from F, Cl, Br, I, alkyl, aryl, heteroalkyl, heteroaryl, fluoroalkyl, fluoroaryl,
R is the same or different at each occurrence and is selected from X, H, alkyl, aryl, heteroalkyl, heteroaryl, fluoroalkyl, fluoroaryl, arylalkyl, and a crosslinkable group, or two R groups on the same N can together form a non-aromatic ring,
m is an integer from 1 through 5,
n is the same or different at each occurrence and is an integer from 1 through 5,
p is the same or different at each occurrence and is 0 or an integer from 1 through 4, and
q is 0 or an integer from 1 through 4.

2. The polymer of claim 1, wherein the polymerizable group is selected from alkenylene groups, alkynylene groups, cyclic ethers, acrylates, and methacrylates.

3. The polymer of claim 1, wherein X further comprises a linking group.

4. The polymer of claim 3, wherein the linking group is selected from alkylene, heteroalkylene, arylene, and heteroarylene.

5. The polymer of claim 1, wherein R is an alkyl group having from 1 to 6 carbon atoms.

6. The polymer of claim 1, wherein R is selected from phenyl, benzyl, and naphthyl.

7. The polymer of claim 1, wherein both R together form a carbazole group.

8. The polymer of claim 1, wherein Z is selected from an alkyl group having from 1 to 6 carbon atoms, phenyl, and naphthyl.

9. The polymer of claim 1, wherein n=1 and p=1.

10. The polymer of claim 9, wherein m=1, q=0, and Z is an alkyl group.

11. The polymer of claim 1, wherein Monomer (I) is

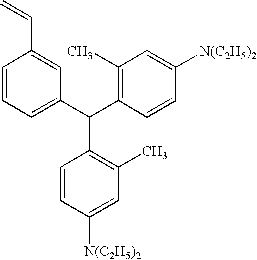

12. The polymer of claim 1, wherein m is 2.

13. The polymer of claim 1, wherein p=1 and Z is a crosslinkable group.

14. The polymer of claim 13, wherein Z is selected from vinyl groups, acryloyl, methacryloyl, cyclic ethers, cinnamoyl esters, benzocyclobutane, and siloxanes.

15. The polymer of claim 1, wherein the polymer comprises a copolymer of Monomer (I) and at least one second monomer.

16. The polymer of claim 15, wherein the second monomer is selected from aromatic vinyl compounds, acrylic esters, vinyl cyanides, vinyl esters, vinyl ethers, vinyl halides, unsaturated polycarboxylic acid, unsaturated polycarboxylic ester, unsaturated polycarboxylic anhydride, maleimides vinylcarbazoles, (meth)acrylic esters of N-4-alkylphenylcarbazole, (meth)acrylic esters of an alkyl substituted N-phenylcarbazole, N,N-diphenylaminophenylalkyl(meth)acrylate)s, and vinylferrocene.

17. A charge transport layer comprising a polymer made from Monomer (I) 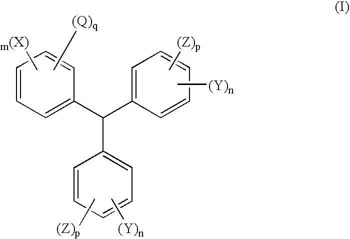
wherein:
X is the same or different at each occurrence and comprises a polymerizable group,
Y is NR₂,
Z is the same or different at each occurrence and is selected from X, F, Cl, Br, I, alkyl, aryl, heteroalkyl, heteroaryl, fluoroalkyl, fluoroaryl, and a crosslinkable group,
Q is the same or different at each occurrence and is selected from F, Cl, Br, I, alkyl, aryl, heteroalkyl, heteroaryl, fluoroalkyl, fluoroaryl,
R is the same or different at each occurrence and is selected from X, H, alkyl, aryl, heteroalkyl, heteroaryl, fluoroalkyl, fluoroaryl, arylalkyl, and a crosslinkable group, or two R groups on the same N can together form a non-aromatic ring,
m is an integer from 1 through 5,
n is the same or different at each occurrence and is an integer from 1 through 5,
p is the same or different at each occurrence and is 0 or an integer from 1 through 4, and
q is 0 or an integer from 1 through 4.

18. The charge transport layer of claim 17, wherein n=1 and p=1.

19. The charge transport layer of claim 18, wherein m=1, q=0, and Z is an alkyl group.

20. The charge transport layer of claim 17, wherein Monomer (I) is

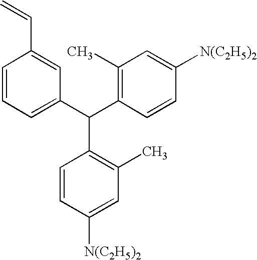

21. An electronic device comprising at least one layer comprising a polymer made from Monomer (I) 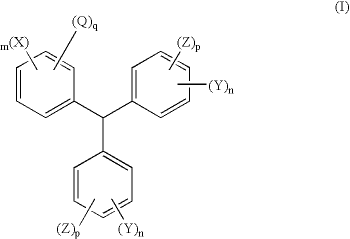
wherein:
X is the same or different at each occurrence and comprises a polymerizable group,
Y is NR₂,
Z is the same or different at each occurrence and is selected from X, F, Cl, Br, I, alkyl, aryl, heteroalkyl, heteroaryl, fluoroalkyl, fluoroaryl, and a crosslinkable group,
Q is the same or different at each occurrence and is selected from F, Cl, Br, I, alkyl, aryl, heteroalkyl, heteroaryl, fluoroalkyl, fluoroaryl,
R is the same or different at each occurrence and is selected from X, H, alkyl, aryl, heteroalkyl, heteroaryl, fluoroalkyl, fluoroaryl, arylalkyl, and a crosslinkable group, or two R groups on the same N can together form a non-aromatic ring,
m is an integer from 1 through 5,
n is the same or different at each occurrence and is an integer from 1 through 5,
p is the same or different at each occurrence and is 0 or an integer from 1 through 4, and
q is 0 or an integer from 1 through 4.

22. The electronic device of claim 21, wherein n=1 and p=1.

23. The electronic device of claim 22, wherein m=1, q=0, and Z is an alkyl group.

24. The electronic device of claim 21, wherein Monomer (I) is

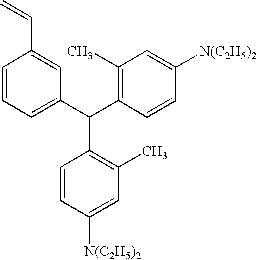

25. The electronic device of claim 21, wherein the device is selected from an organic light-emitting diode, a diode laser, a photodetector, a photoconductive cell, a photoresistor, a photoswitch, a phototransistor, a phototube, an IR detector, a photovoltaic cell, a solar cell, a light sensor, a thin film organic transistor, a photoconductor, and an electrophotographic device.
